(19) United States
(12) Patent Application Publication
(10) Pub. No.: US 2012/0265337 A1
(43) Pub. Date: Oct. 18, 2012

(54) METHOD FOR BANK NOTE DISTRIBUTION OF FINANCIAL SELF-SERVICE EQUIPMENT

(75) Inventors: Zongbin Mu, Guangzhou (CN); Tiancai Liang, Guangzhou (CN); Jia Ding, Guangzhou (CN); Goafeng Du, Guangzhou (CN)

(73) Assignee: GRG Banking Equipment Co., Ltd., Guangzhou, Guangdong (CN)

(21) Appl. No.: 13/512,566

(22) PCT Filed: Nov. 26, 2010
(86) PCT No.: PCT/CN2010/079173

§ 371 Date: May 29, 2012

(30) Foreign Application Priority Data
Dec. 22, 2009 (CN) 200910214023.1

(51) Int. Cl. G06F 17/00

(52) U.S. Cl. 700/239

(57) ABSTRACT

A method for bank note distribution of financial self-service equipment is provided. The method includes: whether the distributed bank note amount is less than or equal to the residual bank note amount of a bank note box in the financial self-service equipment is judged, if yes, the lowest common multiple of bank note face value in the financial self-service equipment is obtained, otherwise, the bank note distribution fails; quotient and remainder obtained by dividing the distributed bank note amount by the lowest common multiple form the base number and the mantissa of the distributed bank note amount respectively; the base number part of the distributed bank note amount is distributed according to the bank note distribution principle; the remaining amount of the distributed bank note amount which carries out base number distribution and the mantissa of the distributed bank note amount form a residual error, and a secondary bank note distribution is performed on the residual error by an exhaustion method, where the bank note distribution succeeds when combination satisfying the residual error is present, otherwise, the bank note distribution fails.

This application claims priority to Chinese Patent Application no. 200910214023.1, filed with the Chinese Patent Office on Dec. 22, 2009 and entitled “Method for Banknote Mix of Financial Self-Service Equipment”, which is hereby incorporated by reference in its entirety.

### FIELD OF THE INVENTION

The present invention relates to the field of finances and in particular to a method for banknote mix of a financial self-service device.

### BACKGROUND OF THE INVENTION

Banknote mix of a financial self-service device refers to overall management on the numbers of banknotes in respective banknote boxes of an Automatic Teller Machine (ATM). Typically, a financial self-service device, i.e., an Automatic Teller Machine (ATM), is equipped with N (N≧1) banknote boxes in each of which there are separately stored banknotes with a specific denomination, and the respective banknote boxes can store therein banknotes with the same sum or different sums of denominations.

In view of both satisfying the demand of a user and facilitating maintenance of supplementing banknotes while dispensing banknotes, a banknote mix system of a financial self-service device manages banknote mix of the financial self-service device dependent upon an amount of banknotes entered by the user and a condition of banknotes stored in banknote boxes.

Typically, four banknote mix principles exist with practical application demands:

(1) Uniformly emptying principle: respective banknote boxes are emptied with substantially equal probabilities.

(2) Averaging principle: the numbers of banknotes dispensed from respective banknote boxes in a specific combination are substantially equal.

(3) Maximum denomination principle: banknotes are dispensed preferentially from the banknote box with larger denomination banknotes to minimize the total number of dispensed banknotes.

(4) Minimum denomination principle: banknotes are dispensed preferentially from the banknote box with smaller denomination banknotes to maximize the total number of dispensed banknotes.

During banknote mix on the foregoing principles, however, an amount of banknotes entered by a user is indeterminate, so a condition of banknotes stored in banknote boxes is also indeterminate. In an existing method for banknote mix of a financial self-service device, an exhaustive search has to be performed in view of the number of banknote boxes and the numbers of banknotes therein to determine respectively whether banknotes can be mixed successfully in respective combinations of the banknote boxes, and banknotes can be dispensed only upon determining successful banknote mix. The problem of time-consuming and inefficient banknote mix may arise when the existing method for banknote mix of a financial self-service device performs the banknote mix for a number of banknote boxes with various denominations.

### SUMMARY OF THE INVENTION

In view of this, the invention provides a method for banknote mix of a financial self-service device to perform rapid and efficient banknote mix.

The method for banknote mix of a financial self-service device includes:

determining whether an amount of banknotes to be mixed is not larger than amounts of banknotes remaining in banknote boxes of the financial self-service device, and if not, then calculating least common multiple of denominations of banknotes in the financial self-service device; otherwise, failing banknote mix;

dividing the amount of banknotes to be mixed by the least common multiple, taking the quotient and the remainder respectively, forming a base and a mantissa;

mixing banknotes for the base of the amount of banknotes to be mixed on a banknote mix principle; and

taking the sum of the amount of remaining banknotes of the base after the banknote mix and the mantissa of the amount of banknotes to be mixed as a residual, and performing a second banknote mix for the residual on exhaustion method, and if there exists a solution in compliance with the residual, then succeeding in banknote mix; otherwise, failing banknote mix.

Preferably, before the step of forming the base and the mantissa of the amount of banknotes to be mixed, the method further comprises: calculating the numbers of banknotes reserved in the banknote boxes with the respective denomination banknotes based on the denominations of the banknote in the respective banknote boxes of the financial self-service device and the least common multiple thereof.

Preferably, the numbers of banknotes reserved in the banknote boxes with the respective denominations are equal to the value by subtracting 1 from the respective denominations of the banknote boxes divided by the least common multiple.

Preferably, before the step of calculating the least common multiple of the denominations of banknotes in the financial self-service device, the method further comprises: calculating largest common divisor of the denominations of banknotes in the financial self-service device, determining whether the amount of banknotes to be mixed is dividable exactly by the largest common divisor, and if so, then going on the banknote mix process; otherwise, failing banknote mix.

Preferably, the banknote mix principle is equal-emptying principle, averaging principle, maximum denomination principle or minimum denomination principle.

Preferably, if the banknote mix principle is equal-emptying principle, the step of mixing banknotes for the base of the amount of banknotes to be mix on the banknote mix principle includes:

counting the numbers of banknotes in the respective banknote boxes and determining one of the banknote boxes with the largest number of banknotes; and

calculating the number of banknotes dispensed from the banknote box with the largest number of banknotes and dispensing the corresponding numbers of banknotes from the respective banknote boxes.

Preferably, if the banknote mix principle is averaging principle, the step of mixing the base of the amount of banknotes to be mixed on the banknote mix principle includes:

counting the numbers of banknotes in the respective banknote boxes; and

calculating the numbers of banknotes dispensed from the respective banknote boxes in a mode of dispensing equal numbers of banknotes from the respective banknote boxes and dispensing the corresponding numbers of banknotes from the respective banknote boxes.

Preferably, if the banknote mix principle is maximum denomination principle, the step of mixing banknotes for the base of the amount of banknotes to be mixed on the banknote mix principle includes:

counting the numbers of banknotes in the respective banknote boxes; and

calculating the numbers of banknotes dispensed from the respective banknote boxes in a mode of dispensing banknotes preferentially from one of the banknote boxes with the largest denomination of banknotes and dispensing the corresponding numbers of banknotes from the respective banknote boxes.

Preferably, if the banknote mix principle is minimum denomination principle, the step of mixing banknotes for the base of the amount of banknotes to be mixed on the banknote mix principle includes:

counting the numbers of banknotes in the respective banknote boxes; and

calculating the numbers of banknotes dispensed from the respective banknote boxes in a mode of dispensing banknotes preferentially from one of the banknote boxes with the smallest denomination of banknotes and dispensing the corresponding numbers of banknotes from the respective banknote boxes.

Preferably, the step of performing the second banknote mix for the residual on exhaustion method comprises:

determining a conditional multivariate equation from the residual, the respective denominations of banknotes and the corresponding remaining amounts of banknotes of the respective denominations in the financial self-service device; and

solving the constrained multivariate equation as combinations of the numbers of banknotes dispensed from the respective banknotes by exhaustion method and finishing banknote mix if any of the combinations is successful.

As can be apparent from the foregoing solutions, in the method for banknote mix of a financial self-service device according to the invention, firstly it is determined prior to banknote mix whether the amounts of banknotes remaining in the financial self-service device is sufficient for banknote mix, and if not so, then banknote mix fails; otherwise, the base and the mantissa of the amount of banknotes to be mixed are calculated so that firstly the banknote mix is performed for the base of the amount of banknotes to be mixed on the banknote mix principle, and then the sum of the amount of remaining banknotes of the base after the banknote mix and the mantissa of the amount of banknotes to be mixed is took as a residual on exhaustion method, a second banknote mix is performed for the residual, and if there exists a combination in compliance with the residual, then banknote mix succeeds; otherwise, banknote mix fails. Since the base of the amount of banknotes to be mixed are mixed firstly and then the residual is mixed on exhaustion method, it is not necessary to determine respectively whether banknotes can be mixed successfully in each of combinations of the respective banknote boxes; and since the residual is a small magnitude relative to the amount of banknotes to be mixed, a just a short period of time will be spent even for performing banknote mix by exhaustion method, thereby achieving rapid and efficient banknote mix.

### BRIEF DESCRIPTION OF THE DRAWINGS

In order to make the solutions according to the embodiments of the invention or in the prior art more apparent, the drawings used to describe the embodiments or the prior art will be introduced briefly. Apparently, the drawings described below merely illustrate some of the embodiments of the invention, and those ordinarily skilled in the art can derive from these drawings other drawings without any inventive effort. In the drawings:

FIG. 1 illustrates a flow chart of a method for banknote mix of a financial self-service device according to an embodiment of the invention;

FIG. 2 illustrates a flow chart of banknote mix on the equal-emptying principle according to an embodiment of the invention;

FIG. 3 illustrates a flow chart of banknote mix on the averaging principle according to an embodiment of the invention;

FIG. 4 illustrates a flow chart of banknote mix on the maximum denomination principle according to an embodiment of the invention;

FIG. 5 illustrates a flow chart of banknote mix on the minimum denomination principle according to an embodiment of the invention;

FIG. 6(a) illustrates a schematic diagram of mixing and dispensing banknotes on the equal-emptying principle according to an embodiment of the invention;

FIG. 6(b) illustrates a schematic diagram of mixing and dispensing banknotes on the equal-emptying principle according to an embodiment of the invention;

FIG. 6(c) illustrates a schematic diagram of mixing and dispensing banknotes on the equal-emptying principle according to an embodiment of the invention;

FIG. 6(d) illustrates a schematic diagram of mixing and dispensing banknotes on the equal-emptying principle according to an embodiment of the invention;

FIG. 7(a) illustrates a schematic diagram of mixing and dispensing banknotes on the averaging principle according to an embodiment of the invention;

FIG. 7(b) illustrates a schematic diagram of mixing and dispensing banknotes on the averaging principle according to an embodiment of the invention;

FIG. 7(c) illustrates a schematic diagram of mixing and dispensing banknotes on the averaging principle according to an embodiment of the invention; and

FIG. 7(d) illustrates a schematic diagram of mixing and dispensing banknotes on the averaging principle according to an embodiment of the invention.

### DETAILED DESCRIPTION OF THE INVENTION

The solutions according to the embodiments of the invention will be clearly and fully described below with reference to the drawings in the embodiments of the invention. Apparently, the embodiments described below are merely some but not all of embodiments of the invention. Any other embodiments that will occur to those ordinarily skilled in the art in light of the embodiments of the invention here shall come into the scope of the invention.

An embodiment of the invention discloses a method for banknote mix of a financial self-service device to perform rapid and efficient banknote mix.

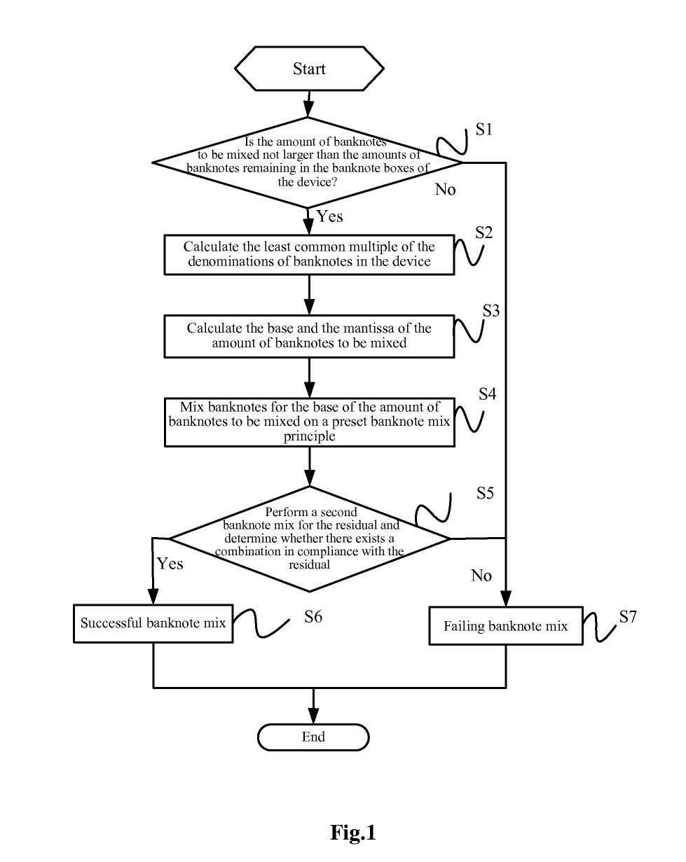

Particularly as illustrated in FIG. 1, the method for banknote mix of a financial self-service device includes:

The step S1 of determining whether an amount of banknotes to be mixed is not larger than an amount of banknotes remaining in banknote boxes of the financial self-service device, and if not, then going to the step S2; otherwise, going to the step S7.

The step S2 of calculating the least common multiple of denominations of banknotes in the financial self-service device.

The step S3 of dividing the amount of banknotes to be mixed by the least common multiple and taking the quotient and the remainder respectively, forming a base and a mantissa.

The step S4 of mixing banknotes for the base of the amount of banknotes to be mixed on a banknote mix principle.

Specifically, the banknote mix principle is any one of equal-emptying principle, averaging principle, maximum denomination principle and minimum denomination principle, and of course, banknotes can be mixed for the base of the amount of banknotes to be mixed alternatively on any other banknote mix principle.

The step S5 of taking the sum of the amount of remaining banknotes of the base after the banknote mix and the mantissa of the amount of banknotes to be mixed as a residual, and performing a second banknote mix for the residual on exhaustion method, and if there exists a combination in compliance with the residual, then going to the step S6 indicating successful banknote mix; otherwise, going to the step S7 indicating failing banknote mix.

In the method for banknote mix according to the foregoing embodiment, two results of successful banknote mix and failing banknote mix can be displayed on an interface or indicated with different rings as in the prior art.

Specifically, in order to improve a successful probability of the method for banknote mix of a financial self-service device, the method can further calculating the numbers of banknotes reserved in the respective banknote boxes of the financial self-service device corresponding to the least common multiple of the denominations of banknotes after the step S2 is performed.

The numbers of reserved banknotes are calculated by subtracting 1 from the denominations of the respective banknote boxes of the financial self-service device divided by the least common multiple of the denominations of banknotes. Thus, remaining banknotes can be ensured in the respective banknote boxes of the financial self-service device for subsequent calculation of the residual.

Furthermore, before the step of calculating the least common multiple of the denominations of banknotes in the financial self-service device, the method for banknote mix of a financial self-service device can further include calculating the greatest common divisor of the denominations of banknotes in the financial self-service device, determining whether the amount of banknotes to be mixed is divisible exactly by the greatest common divisor, and if so, then going on the banknote mix process; otherwise, failing banknote mix.

A banknote mix method based on four respective banknote mix principles will be detailed below in four embodiments.

Assumed:

(1) A financial self-service device is equipped with N (N≧1) banknote boxes;

(2) Denominations of the banknotes in the respective banknote boxes are indicated by C, (i=1, 2, . . . , N), where the denominations of the banknotes in the respective banknote boxes may or may not be equal;

(3) The number of banknotes in the respective banknote boxes are indicated by Q, (i=1, 2, . . . , N); and

(4) An amount of banknotes to be mixed is X, where the amount of banknotes to be mixed is divided into two parts: X=W+E, wherein W denotes a base and E denotes a mantissa.

The equal-emptying principle is adopted in a first embodiment.

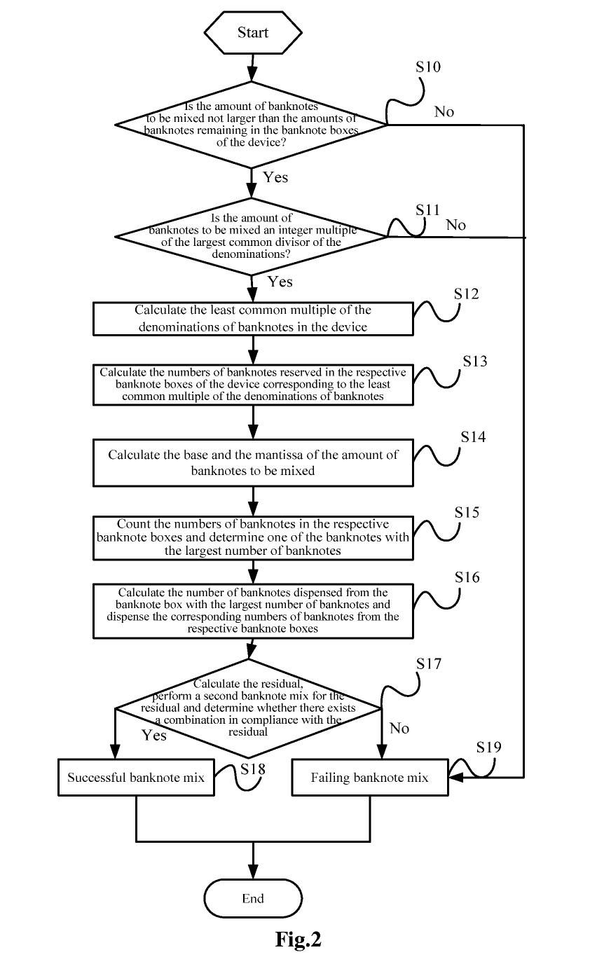

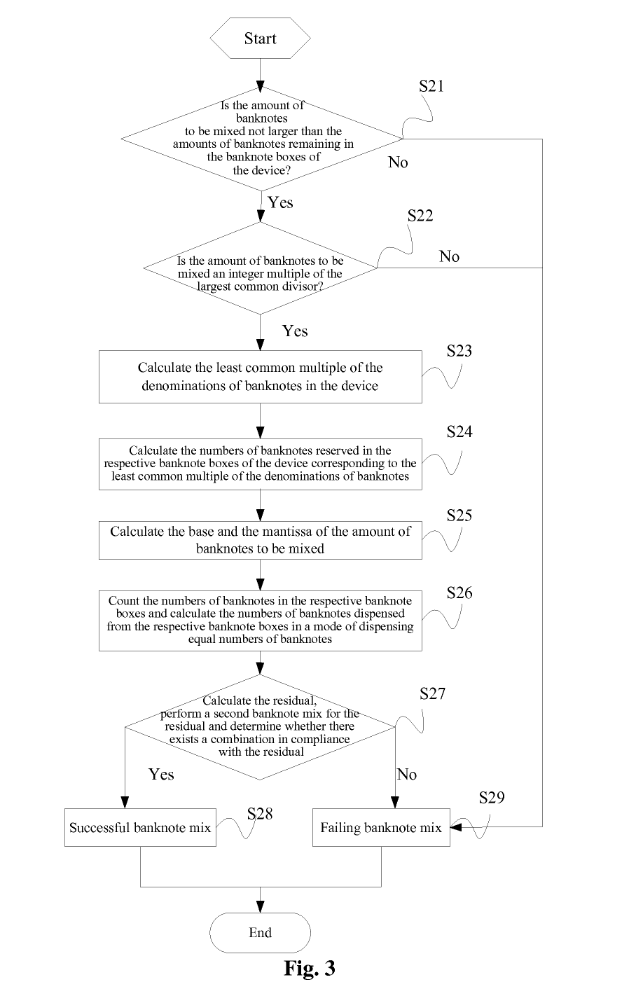

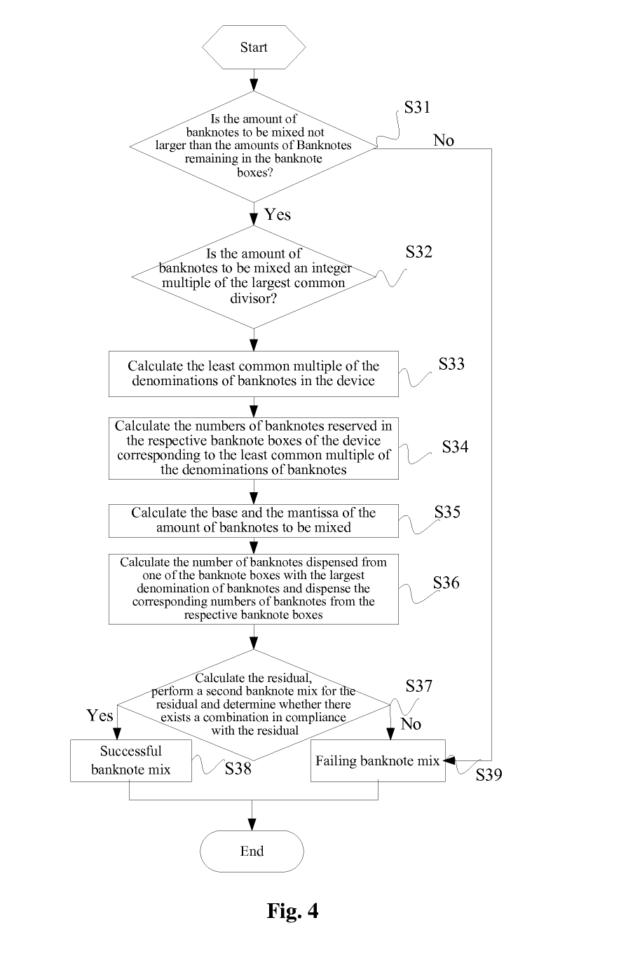

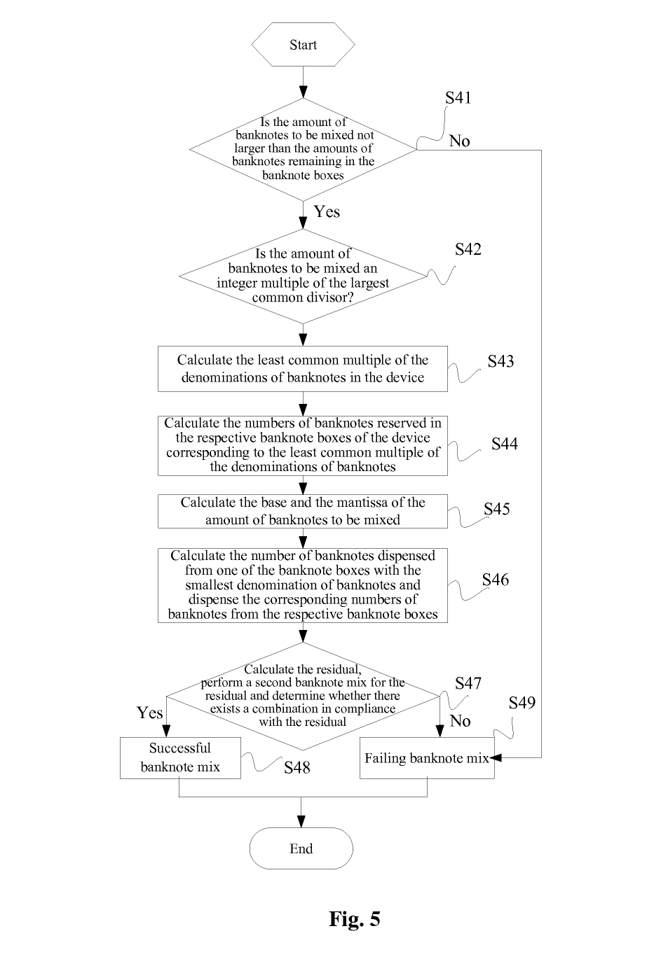

As illustrated in FIG. 2, the method includes:

The step S10 of calculating amounts of banknotes remaining in the respective banknote boxes of the financial self-service devices, comparing the amount of banknotes to be mixed with the amounts of banknotes remaining in the respective banknote boxes, and if the amount of banknotes to be mixed is not larger than the sum of the amounts of banknotes remaining in the respective banknote boxes, then going to the step S11; otherwise, going to the step S19.

Specifically, the sum of the amounts of banknotes remaining in the respective banknote boxes is calculated as

$$S = {\sum }_{i = 0}^{N} {Q}_{i} \times {C}_{i} .$$

The step S11 of calculating the largest common divisor of the denominations of banknotes, determining whether the amount of banknotes to be mixed is an integer multiple of the largest common divisor of the denominations of the banknotes in the respective banknote boxes, and if so, then going to the step S12; otherwise, going to the step S19.

Specifically, it is assumed that the largest common divisor is P and it is determined whether X/P is an integer.

The step S12 of calculating the least common multiple of the denominations of banknotes in the financial self-service device as Z.

The step S13 of calculating the numbers of banknotes reserved in the respective banknote boxes of the financial self-service device corresponding to the least common multiple of the denominations of banknotes.

Specifically, the numbers of banknotes reserved in the respective banknote boxes are calculated as:

$${Y}_{i} = \frac{Z}{{C}_{i}} - 1 , ( i = 1 , 2 , ⋯ , N ) .$$

The step S14 of dividing the amount of banknotes to be mixed by the least common multiple and taking the quotient and the remainder respectively, wherein the quotient is the base of the amount of banknotes to be mixed and the remainder is the mantissa of the amount of banknotes to be mixed.

Specifically, the base of the amount of banknotes to be mixed is calculated as

$$W = ⌊ \frac{X}{Z} ⌋ \times Z ,$$

and the mantissa of the amount of banknotes to be mixed is calculated as E=X−W.

The step S15 of counting the numbers of banknotes in the respective banknote boxes and determining one of the banknote boxes with the largest number of banknotes.

Specifically, the step S15 includes:

(1) Calculating the maximum and the minimum of Qᵢ (i=1, 2, . . . , N), generally Qj=max{Qi} and Qn=min{Qi}.

(2) Calculating the difference between Qᵢ and Q_{N}: Vᵢ=Qᵢ−Q_{N}, (i=1,2, . . . , N).

(3) The following two scenarios exist:

If

$$Vi > ⌊ \frac{Z}{Cn} ⌋ , i = 1 , 2 … n ,$$

then going to the step (4); or

If

$$Vi < ⌊ \frac{Z}{Cn} ⌋ , i = 1 , 2 … n ,$$

then terminating the present step and going to the step S16;

(4) Calculating the number of dispensed banknotes with the denomination Cⱼ corresponding to Qⱼ as

$$mj = ⌊ \frac{Z}{Cj} ⌋ ;$$

(5) If Vⱼ≧mⱼ, then going to (6); otherwise, going to (7);

(6) Recording the real number of dispensed banknotes with the denomination Cⱼ as Mⱼ=Mⱼ+mⱼ;

(7) Calculating Wⱼ=MⱼCⱼ,W=W−Wⱼ and Qⱼ=Qⱼ−Mⱼ, and going back to (1) of the step S15.

The step S16 of calculating the number of banknotes dispensed from the banknote box with the largest number of banknotes and dispensing the corresponding numbers of banknotes from the respective banknote boxes.

Specifically, the step S16 includes:

(1) Let k=1, i=1 and Mᵢ^{k}=0;

(2) Calculating

$${C}_{min} = {min}_{C} \{ {C}_{i} \} , i = 1 , 2 , ⋯ , N ,$$

so the ideal numbers of dispensed banknotes with the respective denominations are

$$B = ⌊ \frac{Z}{{C}_{min}} ⌋ ;$$

(3) If Qᵢ−Mᵢ^{k}−Yᵢ≧B, then jumping to (4); otherwise, jumping to (5);

(4) Recording the number of dispensed banknotes with the denomination Cᵢ as Mᵢ^{k}=Mᵢ^{k}+B.

(5) i=i+1, and if i<N, then jumping to (3); otherwise, jumping to (6);

(6) Calculating

$${W}^{k} = {\sum }_{i = 1}^{N} {M}_{i} {C}_{i} .$$

Then the following scenarios exists:
a) If W>W^{k}, then k=k+1 and jumping to (2);
b) If W<W^{k} , then Mᵢ=Mᵢ^{k-1}, E=E+W−W^{k-1} and jumping to the step S18;
c) If W=W^{k}, then Mᵢ=Mᵢ^{k} and jumping to the step S18.

The step S17 of calculating the residual, performing a second banknote mix for the residual on exhaustion method, and if there exists a combination in compliance with the residual, then going to the step S18 indicating successful banknote mix; otherwise, going to the step S19 indicating failing banknote mix.

Specifically, the second banknote mix for the residual is calculated by solving the constrained multivariate equation

$$E = {\sum }_{i = 1}^{n} {M}_{i}^{′} {C}_{i} , ( {M}_{i}^{′} \leq {Y}_{i} ) ,$$

and if solutions exist with the equation, then a set of solutions M′ᵢ, (i=1,2, . . . , N) is taken. At this time, the number of dispensed banknotes with the denomination Cᵢ is M₁=M′ᵢ+Mᵢ, thereby succeeding in banknote mix.

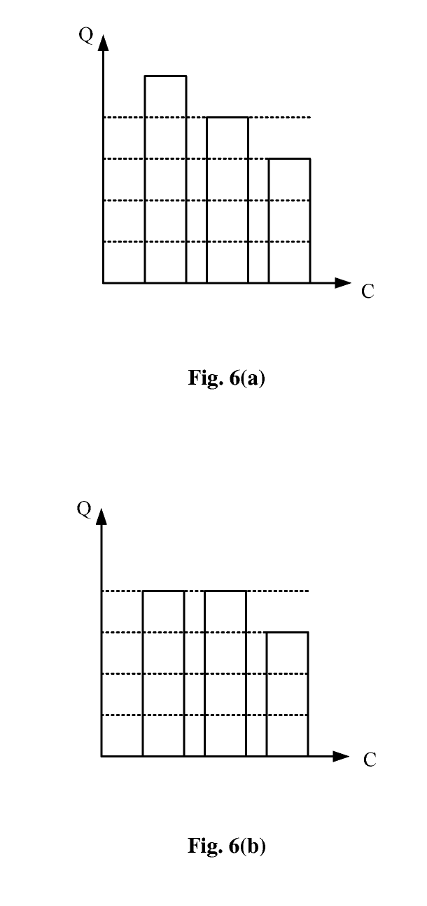

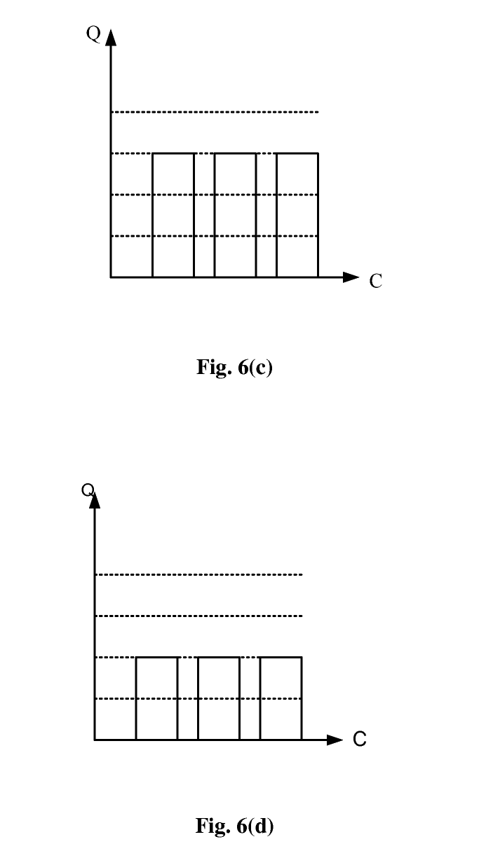

As illustrated in FIG. 6(a) to FIG. 6(d), each of rectangles represents one of the denominations, and the height of the rectangle represents the number of banknotes with that denomination. The flow of dispensing banknotes on the equal-emptying principle is performed sequentially as in FIG. 6(a) to FIG. 6(d) by shortening firstly the higher rectangles and then the shorter rectangles until the respective rectangles are equal in height where the number of banknotes in the respective banknotes is substantially equal.

The averaging principle is adopted in a second embodiment, which includes:

The step S21 of calculating amounts of banknotes remaining in the respective banknote boxes of the financial self-service devices, comparing the amount of banknotes to be mixed with the amounts of banknotes remaining in the respective banknote boxes, and if the amount of banknotes to be mixed is not larger than the amounts of banknotes remaining in the respective banknote boxes, then going to the step S22; otherwise, going to the step S29.

Specifically, the sum of the amounts of banknotes remaining in the respective banknote boxes, are calculated as

$$S = {\sum }_{i = 0}^{N} {Q}_{i} \times {C}_{i} .$$

The step S22 of calculating the largest common divisor of the denominations of banknotes, determining whether the amount of banknotes to be mixed is an integer multiple of the largest common divisor of the denominations of banknotes, and if so, then going to the step S23; otherwise, going to the step S29.

Specifically, it is assumed that the largest common divisor is P, it is determined whether X/P is an integer.

The step S23 of calculating the least common multiple of the denominations of banknotes in the financial self-service device as Z.

The step S24 of calculating the numbers of banknotes reserved in the respective banknote boxes of the financial self-service device corresponding to the least common multiple of the denominations of banknotes.

Specifically, the numbers of banknotes reserved in the respective banknote boxes are calculated as:

$${Y}_{i} = \frac{Z}{{C}_{i}} - 1 , ( i = 1 , 2 , ⋯ , N ) .$$

The step S25 of dividing the amount of banknotes to be mixed by the least common multiple and taking the quotient and the remainder respectively, wherein the value of multiplying the quotient by the least common multiple is the base of the amount of banknotes to be mixed and the remainder is the mantissa of the amount of banknotes to be mixed.

Specifically, the base of the amount of banknotes to be mixed is calculated as

$$W = ⌊ \frac{X}{Z} ⌋ \times Z ,$$

and the mantissa of the amount of banknotes to be mixed is calculated as E=X−W.

The step S26 of counting the numbers of banknotes in the respective banknote boxes and calculating the numbers of banknotes dispensed from the respective banknote boxes in a mode of equal numbers of banknotes dispensed from the respective banknote.

Specifically, the step S26 includes:

(1) Let k=1, i=1 and Mᵢ^{k}=0;

(2) Calculating

$${C}_{min} = {min}_{C} \{ {C}_{i} \} , i = 1 , 2 , ⋯ , N ,$$

so the ideal numbers of dispensed banknotes with the respective denominations are

$$B = ⌊ \frac{Z}{{C}_{min}} ⌋ ;$$

(3) If Qᵢ−Mᵢ^{k}−Yᵢ≧B, then jumping to (4); otherwise, jumping to (5);

(4) Recording the number of dispensed banknotes with the denomination Cᵢ as Mᵢ^{k}=Mᵢ^{k}+B.

(5) i=i+1, and if i<N, then jumping to (3); otherwise, jumping to (6);

(6) Calculating

$${W}^{k} = {\sum }_{i = 1}^{N} {M}_{i} {C}_{i} .$$

Then the following scenarios exists:

a) If W>W^{k}, then k=k+1 and jumping to (2);

b) If W<W^{k}, then Mᵢ=Mᵢ^{k-1}, E=E+W−W^{k-1} and jumping to the step S27;

c) If W=W^{k}, then Mᵢ=Mᵢ^{k} and jumping to the step S27.

The step S27 of calculating the residual, performing a second banknote mix for the residual on exhaustion method, and if there exists a combination in compliance with the residual, then going to the step S28 indicating successful banknote mix; otherwise, going to the step S29 indicating failing banknote mix.

Specifically, the second banknote mix for the residual is calculated by solving the constrained multivariate equation

$$E = {\sum }_{i = 1}^{n} {M}_{i}^{′} {C}_{i} , ( {M}_{i}^{′} \leq {Y}_{i} ) ,$$

and if solutions exist with the equation, then a set of solutions M′ᵢ, (i=1,2, . . . , N) is taken. At this time, the number of dispensed banknotes with the denomination Cᵢ is Mᵢ=M′ᵢ+Mᵢ, thereby succeeding in banknote mix.

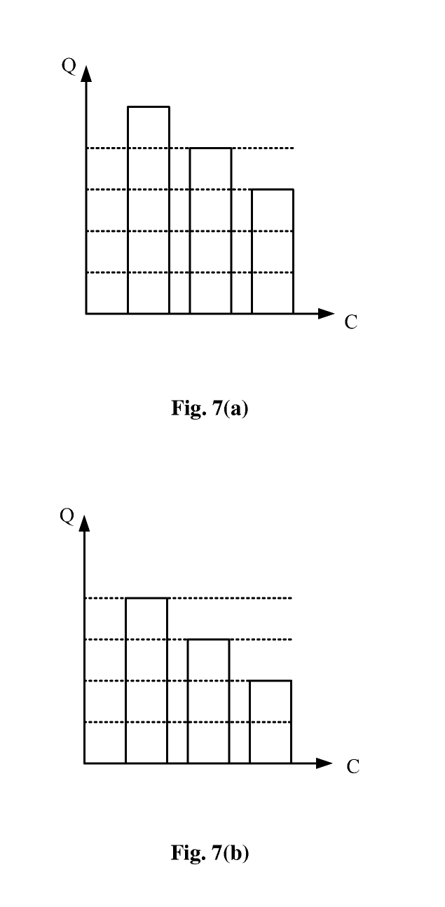

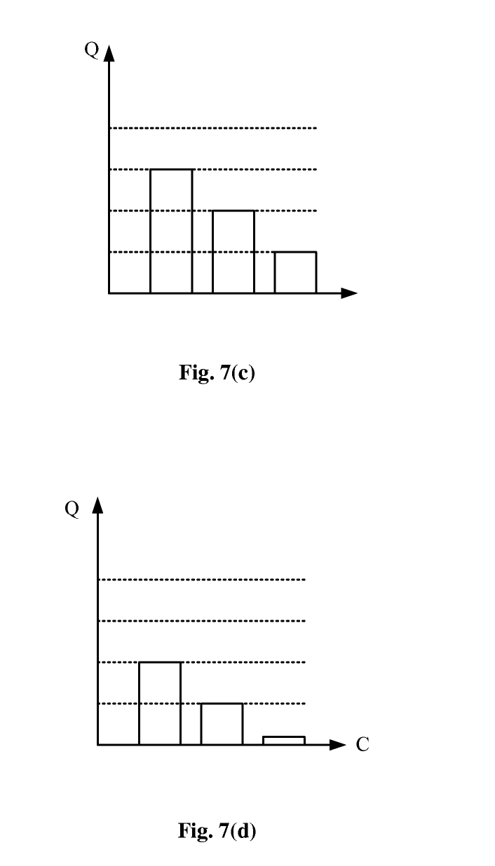

As illustrated in FIG. 7(a) to FIG. 7(d), also each of rectangles represents one of the denominations, and the height of the rectangle represents the number of banknotes with that denomination. The flow of dispensing banknotes on the averaging principle is performed sequentially as in FIG. 7(a) to FIG. 7(d) by excluding blocks with equal heights (i.e., equal numbers of bank notes) from the respective rectangles from top to bottom.

The maximum denomination principle is adopted in a third embodiment, which includes:

The step S31 of calculating amounts of banknotes remaining in the respective banknote boxes of the financial self-service devices, comparing the amount of banknotes to be mixed with the amounts of banknotes remaining in the respective banknote boxes, and if the amount of banknotes to be mixed is not larger than the sum of the amounts of banknotes remaining in the respective banknote boxes, then going to the step S32; otherwise, going to the step S38.

Specifically, the sum of the amounts of banknotes remaining in the respective banknote boxes is calculated as

$$S = {\sum }_{i = 0}^{N} {Q}_{i} \times {C}_{i} .$$

The step S32 of calculating the largest common divisor of the denominations of banknotes, determining whether the amount of banknotes to be mixed is an integer multiple of the largest common divisor of the denominations of banknotes, and if so, then going to the step S33; otherwise, going to the step S39.

Specifically, it is assumed that the largest common divisor is P and it is determined whether X/P is an integer.

The step S33 of calculating the least common multiple of the denominations of banknotes in the financial self-service device as Z.

The step S34 of calculating the numbers of banknotes reserved in the respective banknote boxes of the financial self-service device corresponding to the least common multiple of the denominations of banknotes.

Specifically, the numbers of banknotes reserved in the respective banknote boxes are calculated as:

$${Y}_{i} = \frac{Z}{{C}_{i}} - 1 , ( i = 1 , 2 , … , N )$$

The step S35 of dividing the amount of banknotes to be mixed by the least common multiple and taking the quotient and the remainder respectively, wherein the value of multiplying the quotient by the least common multiple is the base of the amount of banknotes to be mixed and the remainder is the mantissa of the amount of banknotes to be mixed.

Specifically, the base of the amount of banknotes to be mixed is calculated as

$$W = ⌊ \frac{X}{Z} ⌋ \times Z ,$$

and the mantissa of the amount of banknotes to be mixed is calculated as E=X−W.

The step S36 of counting the numbers of banknotes in the respective banknote boxes, calculating the number of banknotes dispensed from the banknote boxes with the largest denomination of banknotes and dispensing the corresponding numbers of banknotes from the respective banknote boxes.

Specifically, the step S36 includes:

(1) k=0;

(2) Calculating

$${C}_{j} = {max}_{C} \{ {C}_{i} \vert {C}_{i} ∈ C \} ,$$

so the ideal number of dispensed banknotes with the denomination Cⱼ is

$$B = ⌊ \frac{W}{{C}_{j}} ⌋ ;$$

(3) If Qⱼ−Yⱼ≧B, then going to (4); otherwise, going to (5);

(4) Calculating the number of dispensed banknotes with the denomination Cⱼ as Mⱼ=B, and going to the step S36.

(5) Calculating the number of dispensed banknotes with the denomination Cⱼ as Mⱼ=Qⱼ−Yⱼ, and calculating Wⱼ=Mⱼ×Cⱼ and W=W−Wⱼ.

(6) Excluding Cⱼ from the queue C, i.e., C={Cᵢ|i≠j,i=1,2, . . . , N}.

(7) k=k+1. If k<N, then performing (2) again; otherwise, E=E+W and going to the step S36.

The step S37 of calculating the residual, performing a second banknote mix for the residual on the exhaustion method, and if there exists a combination in compliance with the residual, then going to the step S38 indicating successful banknote mix; otherwise, going to the step S39 indicating failing banknote mix.

Specifically, the second banknote mix for the residual is calculated by solving the constrained multivariate equation

$$E = {\sum }_{i = 1}^{n} {M}_{i}^{′} {C}_{i} , ( {M}_{i}^{′} \leq {Y}_{i} ) ,$$

and if solutions exist with the equation, then a set of solutions M′ᵢ, (i=1,2, . . . , N) is taken. At this time, the number of dispensed banknotes with the denomination Cᵢ is Mᵢ=M′ᵢ+Mᵢ, thereby succeeding in banknote mix.

The minimum-par-value principle is adopted in a fourth embodiment, which includes:

The step S41 of calculating amounts of banknotes remaining in the respective banknote boxes of the financial self-service devices, comparing the amount of banknotes to be mixed with the amounts of banknotes remaining in the respective banknote boxes, and if the amount of banknotes to be mixed is smaller than the amounts of banknotes remaining in the respective banknote boxes, then going to the step S42; otherwise, going to the step S48.

Specifically, the sum of the amounts of banknotes remaining in the respective banknote boxes, are calculated as

$$S = {\sum }_{i = 0}^{N} {Q}_{i} \times {C}_{i} .$$

The step S42 of calculating the largest common divisor of the denominations of banknotes, determining whether the amount of banknotes to be mixed is an integer multiple of the largest common divisor of the denominations of banknotes, and if so, then going to the step S43; otherwise, going to the step S49.

Specifically, it is assumed that the largest common divisor is P, it is determined whether X/P is an integer.

The step S43 of calculating the least common multiple of the denominations of banknotes in the financial self-service device as Z.

The step S44 of calculating the numbers of banknotes reserved in the respective banknote boxes of the financial self-service device corresponding to the least common multiple of the denominations of banknotes.

Specifically, the numbers of banknotes reserved in the respective banknote boxes are calculated as:

$${Y}_{i} = \frac{Z}{{C}_{i}} - 1 , ( i = 1 , 2 , … , N ) .$$

The step S45 of dividing the amount of banknotes to be mixed by the least common multiple and taking the quotient and the remainder respectively, wherein the value of multiplying the quotient by the least common multiple is the base of the amount of banknotes to be mixed and the remainder is the mantissa of the amount of banknotes to be mixed.

Specifically, the base of the amount of banknotes to be mixed is calculated as

$$W = ⌊ \frac{X}{Z} ⌋ \times Z ,$$

and the mantissa of the amount of banknotes to be mixed is calculated as E=X−W.

The step S46 of counting the numbers of banknotes in the respective banknote boxes, calculating the number of banknotes dispensed from the banknote boxes with the smallest denomination of banknotes and dispensing the corresponding numbers of banknotes from the respective banknote boxes.

Specifically, the step S46 includes:

(1) k=0;

(2) Calculating

$${C}_{j} = {min}_{C} \{ {C}_{i} \vert {C}_{i} ∈ C \} ,$$

so the ideal number of dispensed banknotes with the denomination Cⱼ is

$$B = ⌊ \frac{W}{{C}_{j}} ⌋ ;$$

(3) If Qⱼ−Yⱼ≧B, then going to (4); otherwise, going to (5);

(4) Calculating the number of dispensed banknotes with the denomination Cⱼ as Mⱼ=B, and going to the step S46.

(5) Calculating the number of dispensed banknotes with the denomination Cⱼ as Mⱼ=Qⱼ−Yⱼ, calculating Wⱼ=Mⱼ×Cⱼ and W=W−Wⱼ.

(6) Excluding Cⱼ from the queue C, i.e., C={Cᵢ |i≠j,i=1,2, . . . , N}.

(7) k=k+1. If k<N, then performing (2) again; otherwise, E=E+W and going to the step S46.

The step S47 of calculating the residual, performing a second banknote mix for the residual on exhaustion method, and if there exists a combination in compliance with the residual, then going to the step S48 indicating successful banknote mix; otherwise, going to the step S49 indicating failing banknote mix.

Specifically, the second banknote mix for the residual is calculated by solving the constrained multivariate equation

$$E = {\sum }_{i = 1}^{n} {M}_{i}^{′} {C}_{i} , ( {M}_{i}^{′} \leq {Y}_{i} ) ,$$

and if solutions exist with the equation, then a set of solutions M′ᵢ, (i=1,2, . . . , N) is taken. At this time, the number of dispensed banknotes with the denomination Cᵢ is Mᵢ=M′ᵢ+Mᵢ, thereby succeeding in banknote mix.

The foregoing description of the disclosed embodiments enables those skilled in the art to practice or use the invention. Various modifications to these embodiments will become apparent to those skilled in the art, and the general principle defined in the invention can be practiced in other embodiments without departing from the spirit or scope of the invention. Accordingly, the invention will not be limited to these embodiments ad indicated here but shall be accorded with the broadest scope in consistency with the principle and novel features disclosed here.

1. A method for banknote mix of a financial self-service device, comprising:
determining whether an amount of banknotes to be mixed is not larger than amounts of banknotes remaining in banknote boxes of the financial self-service device, and if not, then calculating least common multiple of denominations of banknotes in the financial self-service device; otherwise, failing banknote mix;
dividing the amount of banknotes to be mixed by the, least common multiple taking the quotient and the remainder respectively, and forming a base by multiplying the quotient by the least common multiple and a mantissa by the remainder
mixing banknotes for the base of the amount of banknotes to be mixed on a banknote mix principle; and
taking the sum of the amount of remaining banknotes of the base after the banknote mix and the mantissa of the amount of banknotes to be mixed as a residual and performing a second banknote mix for the residual on exhaustion method, and if there exists a solution in compliance with the residual, then succeeding in banknote mix; otherwise, failing banknote mix.

2. The method for banknote mix according to claim 1, further comprising: before the step of forming the base and the mantissa of the amount of banknotes to be mixed, calculating the numbers of banknotes reserved in the banknote boxes with the respective denominations based on the denominations of the banknote in the respective banknote boxes of the financial self-service device and the least common multiple.

3. The method for banknote mix according to claim 2, wherein the numbers of banknotes reserved in the banknote boxes with the respective denominations are equal to the value by subtracting 1 from the least common multiple divided by the respective denominations of the banknote boxes.

4. The method for banknote mix according to claim 1, further comprising: before the step of calculating the least common multiple of the denominations of banknotes in the financial self-service device, calculating largest common divisor of the denominations of banknotes in the financial self-service device, determining whether the amount of banknotes to be mixed is dividable exactly by the largest common divisor, and if so, then going on the banknote mix process; otherwise, failing banknote mix.

5. The method for banknote mix according to claim 1, wherein the banknote mix principle is equal-emptying principle, averaging principle, maximum denomination principle or minimum denomination principle.

6. The method for banknote mix according to claim 5, wherein if the banknote mix principle is the equal-emptying principle, the step of mixing banknotes for the base of the amount of banknotes to be mixed on the banknote mix principle comprises:
counting the numbers of banknotes in the respective banknote boxes and determining one of the banknote boxes with the largest number of banknotes; and
calculating the number of banknotes dispensed from the banknote box with the largest number of banknotes and dispensing the corresponding numbers of banknotes from the respective banknote boxes.

7. The method for banknote mix according to claim 5, wherein if the banknote mix principle is the averaging principle, the step of mixing banknotes for the base of the amount of banknotes to be mixed on the banknote mix principle comprises:
counting the numbers of banknotes in the respective banknote boxes; and
calculating the numbers of banknotes dispensed from the respective banknote boxes in a mode of dispensing equal numbers of banknotes from the respective banknote boxes and dispensing the corresponding numbers of banknotes from the respective banknote boxes.

8. The method for banknote mix according to claim 5, wherein if the banknote mix principle is the maximum denomination principle, the step of mixing banknotes for the base of the amount of banknotes to be mixed on the banknote mix principle comprises:
counting the numbers of banknotes in the respective banknote boxes; and
calculating the numbers of banknotes dispensed from the respective banknote boxes in a mode of dispensing banknotes preferentially from one of the banknote boxes with the largest denomination of banknotes and dispensing the corresponding numbers of banknotes from the respective banknote boxes.

9. The method for banknote mix according to claim 5, wherein if the banknote mix principle is the minimum denomination principle, the step of mixing banknotes for the base of the amount of banknotes to be mixed on the banknote mix principle comprises:
counting the numbers of banknotes in the respective banknote boxes; and
calculating the numbers of banknotes dispensed from the respective banknote boxes in a mode of dispensing banknotes preferentially from one of the banknote boxes with the smallest denomination of banknotes and dispensing the corresponding numbers of banknotes from the respective banknote boxes.

10. The method for banknote mix according to claim 1, wherein the step of performing the second banknote mix for the residual on exhaustion method comprises:
determining a conditional multivariate equation from the residual, the respective denominations of banknotes and the corresponding remaining amounts of banknotes of the respective denominations in the financial self-service device; and
solving the constrained multivariate equation as combinations of the numbers of banknotes dispensed from the respective banknotes by exhaustion method and finishing banknote mix if any of the combinations is successful.

11. The method for banknote mix according to claim 2, further comprising: before the step of calculating the least common multiple of the denominations of banknotes in the financial self-service device, calculating largest common divisor of the denominations of banknotes in the financial self-service device, determining whether the amount of banknotes to be mixed is dividable exactly by the largest common divisor, and if so, then going on the banknote mix process; otherwise, failing banknote mix. 2696242.1
